(19) United States
(12) Patent Application Publication
(10) Pub. No.: US 2025/0028981 A1
(43) Pub. Date: Jan. 23, 2025

(54) Interface Display Method and Apparatus of Industrial Software

(71) Applicant: Siemens Aktiengesellschaft, München (DE)

(72) Inventors: Ming Kun Yang, Beijing (CN); Ye Hu, Beijing (CN); Ji Li, Beijing (CN); Shun Jie Fan, Beijing (CN)

(73) Assignee: Siemens Aktiengesellschaft, München (DE)

(21) Appl. No.: 18/714,281

(22) PCT Filed: Nov. 30, 2021
(86) PCT No.: PCT/CN2021/134645

§ 371 Date: May 29, 2024

(51) Int. Cl. G06N 5/022; G06N 3/044

(52) U.S. Cl. CPC G06N 5/022; G06N 3/044

(57) ABSTRACT

Various embodiments of the teachings herein include an interface display method for industrial software. An example method includes: obtaining a present operation sequence by a user in a functional interface of industrial software; using a recurrent neural network (RNN) model to predict a next operation of the user according to the present operation sequence by the user, wherein the RNN model is obtained through history operation sequence of the user and history operation sequence of typical users in industrial domain knowledge; and highlighting a functional component of the predicted operation of the user from the functional interface and/or generating navigation corresponding to the predicted operation of the user.

### CROSS-REFERENCE TO RELATED APPLICATIONS

This application is a U.S. National Stage Application of International Application No. PCT/CN2021/134645 filed Nov. 30, 2021, which designates the United States of America, the contents of which are hereby incorporated by reference in their entirety.

### TECHNICAL FIELD

The present disclosure relates to industrial software. Various embodiments of the teachings herein include interface display methods and apparatus of industrial software.

### BACKGROUND

To deal with more application scenario requirements, functional features and user interface components are newly added to industrial software, increasing the complexity of the industrial software while making the industrial software more powerful. To identify and position functional component from complex functional features and user interfaces, user experience is degraded, and it requires user to take more time and energy to learn to use these industrial software. To reduce the complexity of user operations, one method is to predict user behaviors based on user preferences. This method is widely applied to consumption fields such as e-commerce and entertainment. However, this method is poor in accuracy and intelligence, and cannot be applied to the industrial field. Another method is to predefine guidelines and shortcuts. However, this method is passive, and is still unsatisfactory in intelligence and user experience.

### SUMMARY

To resolve the foregoing technical problems, the present disclosure provides interface display methods and apparatus of industrial software to improve the intelligence and user experience of interface display of industrial software. For example, some embodiments of the teachings herein include an interface display method of industrial software comprising: obtaining a present operation sequence by a user in a functional interface of industrial software; using a recurrent neural network (RNN) model to predict a next operation of the user according to the present operation sequence by the user, wherein the RNN model is obtained through history operation sequence of the user and history operation sequence of typical users in industrial domain knowledge; and highlighting a function component of the predicted operation of the user from the functional interface and/or generating navigation corresponding to the predicted operation of the user. In this way, using history operation sequence of the user and history operation sequence of typical users in industrial domain knowledge to train RNN model, and using trained RNN model to predict user's next operation, realizing user-interactive intelligent recommendation in the field of industrial software, thereby improving user experience.

In some embodiments, using a recurrent neural network (RNN) model to predict a next operation of the user comprises: choosing a status data according to the industrial domain knowledge, defining status according to one or more value of the status data, calculating transition probability of the status by the RNN model, and determining user operation corresponding to largest probability of status transition as next operation of the user. In this way, realizing prediction of user operation by status data.

In some embodiments, highlighting a function component of the predicted operation of the user from the functional interface comprises: strengthening display of the predicted functional component and/or weakening display of the non-predicted functional component. In this way, enhancing intelligence of interface display and user experience.

In some embodiments, obtaining a present operation sequence by a user comprises: checking validity of the operation by the user, the user operation is valid if there is information interaction between user and functional interface component. In this way, complexity of intelligent recommendation has been reduced by excluding invalid operation of a user.

In some embodiments, the industrial domain knowledge is stored in an industrial domain knowledge base, the industrial domain knowledge base is created by industrial knowledge graph. In this way, realizing automatic acquisition of industrial domain knowledge, improving automation degree of intelligent recommendation.

As another example, some embodiments include an interface display apparatus of industrial software comprising: an obtaining module, obtaining a present operation sequence by a user in a functional interface of industrial software; a prediction module, using a recurrent neural network (RNN) model to predict a next operation of the user according to the present operation sequence by the user, wherein the RNN model is obtained through history operation sequence of the user and history operation sequence of typical users in industrial domain knowledge; and an adjustment module, configured to: highlighting a function component of the predicted operation of the user from the functional interface and/or generating navigation corresponding to the predicted operation of the user.

In some embodiments, using a recurrent neural network (RNN) model to predict a next operation of the user comprises: choosing a status data according to the industrial domain knowledge, defining status according to one or more value of the status data, calculating transition probability of the status by the RNN model, and determining user operation corresponding to largest probability of status transition as next operation of the user.

In some embodiments, highlighting a function component of the predicted operation of the user from the functional interface comprises: strengthening display of the predicted functional component and/or weakening display of the non-predicted functional component.

In some embodiments, obtaining a present operation sequence by a user comprises: checking validity of the operation by the user, the user operation is valid if there is information interaction between user and functional interface component.

In some embodiments, the industrial domain knowledge is stored in an industrial domain knowledge base, the industrial domain knowledge base is created by industrial knowledge graph.

As another example, some embodiments include an electronic device, comprising a processor, a memory, and an instruction stored in the memory, wherein the instruction is executed by the processor to implement one or more of the methods described herein.

As another example, some embodiments include a computer-readable storage medium storing a computer instruction, wherein the computer instruction is executed to perform one or more of the methods described herein.

### BRIEF DESCRIPTION OF THE DRAWINGS

The following accompanying drawings are intended to schematically illustrate and explain the present disclosure but do not limit the scope thereof. In the drawings:

FIG. 1 is a flowchart of an example interface display method incorporating teachings of the present disclosure;

FIG. 2A and FIG. 2B are schematic diagrams of an example functional interface in an interface display method incorporating teachings of the present disclosure;

FIG. 3 is a schematic diagram of an example cross-interface navigation in an interface display method incorporating teachings of the present disclosure;

FIG. 4 is a schematic diagram of status data in an example interface display method incorporating teachings of the present disclosure;

FIG. 5 is a schematic diagram of status transition incorporating teachings of the present disclosure;

FIG. 6 is a schematic diagram of an example interface display apparatus incorporating teachings of the present disclosure; and

FIG. 7 is a schematic diagram of an example electronic device incorporating teachings of the present disclosure.

### DESCRIPTIONS OF REFERENCE NUMERALS

100 Interface display method
110-130 Steps
210-220 Functional interface
310-330 Functional interface
420-430 user operation
600 Interface display apparatus
610 Obtaining module
620 Prediction module
630 Adjustment module
700 Electronic device
710 Processor
720 Memory
L1-L3 Navigation links
S1-S8 Status

### DETAILED DESCRIPTION

To provide a clearer understanding of the technical features, objectives, and effects of the teachings of the present disclosure, specific implementations thereof are described with reference to the accompanying drawings. Many specific details are set forth in the following description to facilitate a full understanding of the present disclosure, but the teachings may alternatively be implemented in other manners different from those described herein and is therefore not limited by specific embodiments disclosed below.

As shown in this application and the claims, words such as “a/an,” “one,” “one kind,” and/or “the” do not refer specifically to singular forms and may also include plural forms, unless the context expressly indicates an exception. In general, terms “comprise” and “include” merely indicate including clearly identified steps and elements. The steps and elements do not constitute an exclusive list. A method or a device may also include other steps or elements.

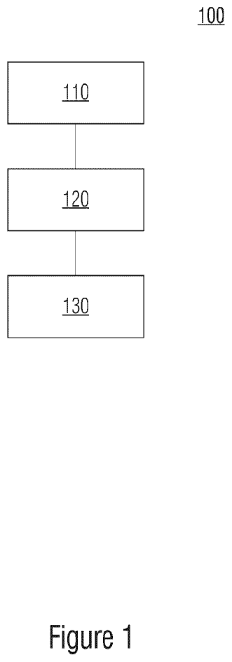

FIG. 1 is a flowchart of an example interface display method 100 incorporating teachings of the present disclosure. The interface display method 100 may run on the back end, used to adjust display of a user interface of the front end. As shown in FIG. 1, the display method 100 includes:

Step 110: Obtaining a present operation sequence by a user in a functional interface of industrial software. Industrial software includes different functional interfaces, and each of the functional interfaces includes a plurality of function components. A user may check among the plurality of function components or adjust data in the function components. The user may also switch from one functional interface to another functional interface. The user may perform operations in a functional interface of the industrial software through a touchscreen or may perform operations in the functional interface of the industrial software through a mouse, a keyboard, or other input devices. In this step, the operation by the user in the functional interface of the industrial software is obtained. Some of the operations by the user on the functional interface may be obtained, or all the operations by the user on the functional interface may be obtained.

In some embodiments, obtaining a present operation sequence by a user in a functional interface of industrial software includes: checking validity of the operation by the user. Validity of user operation could be judged by interaction between user and functional interface component, it's a read operation if a user acquires information from functional interface, and it's a write operation if a user input information to software by functional interface and update data on the backend. In some cases, even a user performs some operations, for example, a series of operation from mouse and keyboard, or switch from windows, which would be regarded as invalid because there is no information interaction. In this way, complexity of intelligent recommendation has been reduced by excluding invalid operation of a user.

Step 120: Using a recurrent neural network (RNN) model to predict a next operation of the user according to the present operation by the user, where the RNN model is obtained through history operation sequence of the user and history operation sequence of typical users in industrial domain knowledge. After the present operation sequence by the user in the functional interface of the industrial software is obtained, the present operation sequence by the user is inputted into an RNN, and the RNN outputs a predicted next operation of the user according to the inputted operation sequence by the user. The RNN is a type of recursive neural network in which a sequence of data is used as an input, recursion is performed in an evolution direction of the sequence, and all nodes are in a chain connection.

The RNN in this embodiment may be a long-short term memory (LSTM) or may be a bidirectional RNN (Bi-RNN). After training and testing, the RNN model may be used for predicting the next operation by the user. The RNN model is obtained through history operation sequence of the user and history operation sequence of typical users in industrial domain knowledge. Typical users may be domain experts or pre-defined by other rules, such as average value in top 50%. By taking user history operation sequence as training data of RNN, the prediction of next operation would cover user's preference, thus improving the accuracy of the prediction result.

Industrial, professional, and common knowledge in knowledge base is called industrial domain knowledge. Industrial domain knowledge may include data type, definition, format, range, etc., relevant relation among data, and other related information in industrial field. Industrial domain knowledge may include industrial software related information, such as organizational structure of graphic user interface, relationship between frontend and backend, definition and function of business-related parameter, workflow.

In some embodiments, data may be acquired by a sensor on the industrial equipment, or parameters of a part or product, for example, a size, material, or position of a work piece. The industrial domain knowledge may be structured data or may be non-structured data. The non-structured data can be used for the training of the RNN after being converted into structured data. The industrial domain knowledge base may be created by domain experts (typical users) by hand or may be obtained automatically by industrial knowledge graph. The industrial knowledge graph includes a plurality of nodes and connection relationships between the plurality of nodes, so that the industrial knowledge can be searched and automatically obtained.

In some embodiments, using an RNN model to predict a next operation of the user according to the present operation sequence by the user includes: choosing status data according to industrial domain knowledge, defining status according to one or more value of the status data, calculating transition probability of the status by RNN model, and determining user operation corresponding to largest probability of status transition as next operation of the user. In some embodiments, multiple user operations may correspond to the same status transition. Status is defined by status data (include but not limited to business-related parameter and other assistive information), and status transition is driven by user operation. Using RNN model to predict next operation of a user, thus predicting probability of status transition.

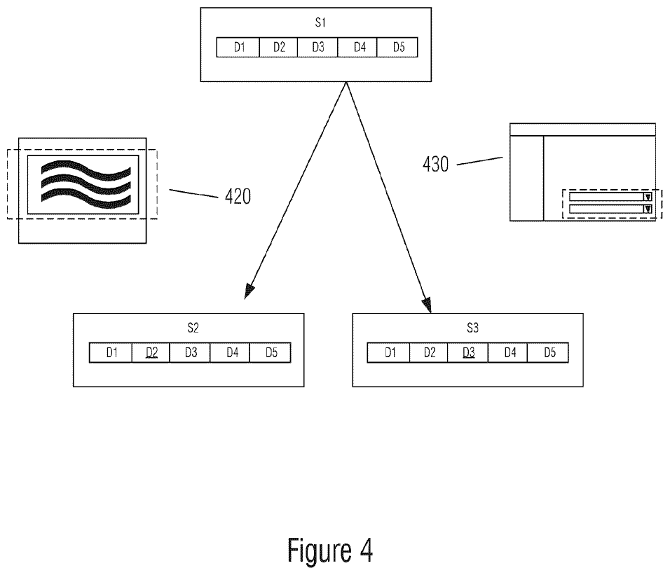

FIG. 4 is a schematic diagram of status data in an interface display method incorporating teachings of the present disclosure. As shown in FIG. 4, status S1 includes status data D1 to D5, the status data D1 to D5 may include more complex data structures, and the status S1 can be defined through the status data D1 to D5. User operation 420 drives transition from status S1 to status S2, status data D2 changes, and other status data remains unchanged. The status S2 may be defined through the change in the status data D2. Similarly, User operation 430 drives transition from status S1 to status S3, status data D3 changes, and other status data remains unchanged. The status S3 may be defined through the change in the status data D3. In this way, the statuses may be defined by identifying the status data.

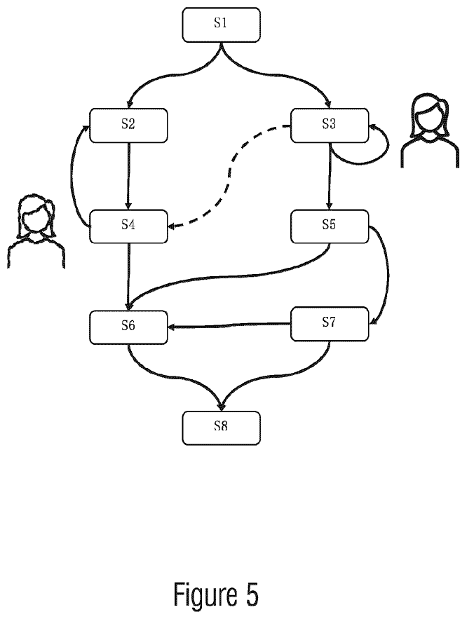

FIG. 5 is a schematic diagram of an example status transition incorporating teachings of the present disclosure. As shown in FIG. 5, a current status is identified to be S3 through the status data first, and the RNN model predicts that the user is most likely to perform an operation switch to a status S4, the probability of status transition is calculated by RNN model.

Step 130: highlighting a functional component of the predicted operation of the user from the functional interface and/or generate navigation corresponding to the predicted operation of the user.

After the operation of the user is predicted, adjustment is performed on the display interface. The adjustment may be intra-interface adjustment or may be inter-interface adjustment. The intra-interface adjustment may be automatically adjustment to display effect of the functional component. The inter-interface adjustment may be generating navigation corresponding to the predicted operation of the user.

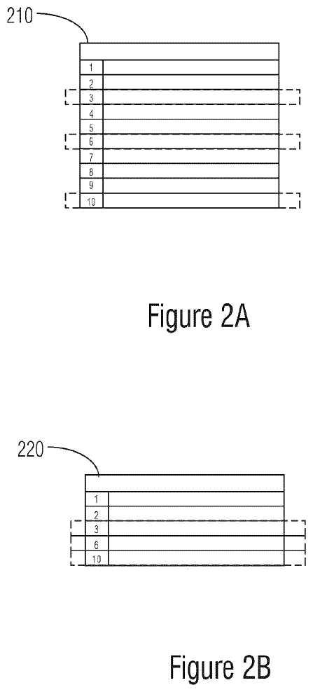

In some embodiments, highlighting a functional component of the predicted operation of the user from the functional interface includes: strengthening display of the predicted functional component and/or weakening display of the non-predicted functional component. For example, strengthening display of the predicted functional component may include expanding display area, text size, adjusting foreground and background, rising contrast, etc. Weakening display of the non-predicted functional component may include shrinking display area, text size, hiding or collapsing etc. FIG. 2A and FIG. 2B are schematic diagrams of a functional interface in an interface display method according to an embodiment of the present invention. As shown in FIG. 2A, a status interface 210 includes 10 functional components, and the user checks a functional component 3. The RNN model predicts that the user is most likely to check a functional component 6 and a functional and therefore strengthening display of the component 10, functional component 6 and the functional component 10, and hides other functional components, as a status interface 220 shown in FIG. 2B.

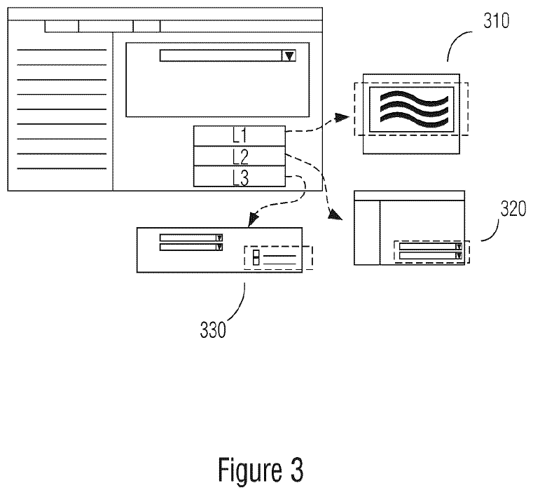

FIG. 3 is a schematic diagram of an example cross-interface navigation in an interface display method incorporating teachings of the present disclosure. As shown in FIG. 3, the RNN model predicts that the user may go to another functional page, screening next operation of the user based on predicted probability, accumulating probability of the interface by adding the probability of functional interface corresponding to operations, therefore builds cross-interface navigation on a current functional page, which is a navigation link L1, a navigation link L2, and a navigation link L3 respectively. The navigation link L1 corresponds to a functional interface 310, the navigation link L2 corresponds to a functional interface 320, and the navigation link L3 corresponds to a functional interface 330, which implements cross-interface intelligent recommendation.

The teachings of the present disclosure include interface display methods using history operation sequence of the user and history operation sequence of typical users in industrial domain knowledge to train RNN model, and using trained RNN model to predict user's next operation, realizing user-interactive intelligent recommendation in the field of industrial software, thereby improving user experience.

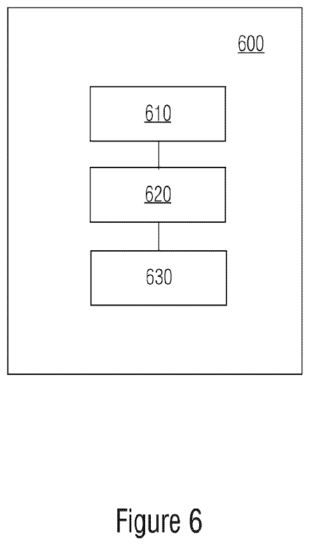

FIG. 6 is a schematic diagram of an example interface display apparatus 600 incorporating teachings of the present disclosure. As shown in FIG. 6, the display apparatus 600 includes: an obtaining module 610, obtaining a present operation sequence by a user in a functional interface of industrial software; a prediction module 620, using a recurrent neural network (RNN) model to predict a next operation of the user according to the present operation sequence by the user, wherein the RNN model is obtained through history operation sequence of the user and history operation sequence of typical users in industrial domain knowledge; and an adjustment module 630, configured to: highlighting a functional component of the predicted operation of the user from the functional interface and/or generating navigation corresponding to the predicted operation of the user.

In some embodiments, using a recurrent neural network (RNN) model to predict a next operation of the user comprises: choosing a status data according to the industrial domain knowledge, defining status according to one or more value of the status data, calculating transition probability of the status by the RNN model, and determining user operation corresponding to largest probability of status transition as next operation of the user.

In some embodiments, highlighting a functional component of the predicted operation of the user from the functional interface comprises: strengthening display of the predicted functional component and/or weakening display of the non-predicted functional component.

In some embodiments, obtaining a present operation sequence by a user comprises: checking validity of the operation by the user, the user operation is valid if there is information interaction between user and functional interface component.

In some embodiments, the industrial domain knowledge is stored in an industrial domain knowledge base, the industrial domain knowledge base is created by industrial knowledge graph.

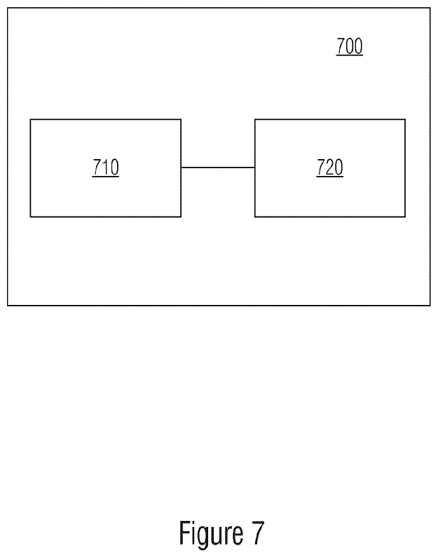

FIG. 7 is a schematic diagram of an example electronic device 700 incorporating teachings of the present disclosure. As shown in FIG. 7, the electronic device 700 includes a processor 710 and a memory 720. The memory 720 stores an instruction. The instruction is executed by the processor 710 to implement the foregoing method 100.

Some aspects of the methods and apparatus may be entirely executed by hardware, may be entirely executed by software (including firmware, resident software, microcode, and the like), or may be executed by a combination of hardware and software. The foregoing hardware or software may be referred to as “data block”, “module”, “engine”, “unit”, “component” or “system”. A processor may be one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or a combination thereof. In addition, various aspects of the present invention may be embodied as computer products located in one or more computer-readable media, the products including computer-readable program code. For example, the computer-readable medium may include, but is not limited to, a magnetic storage device (for example, a hard disk, a floppy disk, a magnetic tape . . . ), an optical disk (for example, a compact disc (CD), a digital versatile disk (DVD), . . . ), a smart card, and a flash memory device (for example, a card, a stick, a key driver, . . . ).

It should be understood that the foregoing operations are not necessarily performed precisely according to the order. On the contrary, the operations may be performed in a reverse order or simultaneously. In addition, other operations are added to these processes, or one or more operations are removed from these processes.

It should be understood that, although this specification describes several example embodiment, each embodiment may not include only one independent technical solution. The description manner of this specification is merely for clarity. This specification should be considered as a whole by a person skilled in the art, and the technical solution in each embodiment may also be properly combined, to form other implementations that can be understood by the person skilled in the art.

The foregoing descriptions are merely specific schematic implementations of the teachings herein and are not intended to limit the scope of the present disclosure. Any equivalent change, modification, and combination made by the person skilled in the art without departing from the conception and principles of the present disclosure should all fall within the protection scope thereof.

What is claimed is:

1. An interface display method for industrial software, the method comprising:
obtaining a present operation sequence by a user in a functional interface of industrial software;
using a recurrent neural network (RNN) model to predict a next operation of the user according to the present operation sequence by the user, wherein the RNN model is obtained through history operation sequence of the user and history operation sequence of typical users in industrial domain knowledge; and
highlighting a functional component of the predicted operation of the user from the functional interface and/or generating navigation corresponding to the predicted operation of the user.

2. The interface display method according to claim 1, wherein using a RNN model to predict a next operation of the user comprises:
choosing a status data according to the industrial domain knowledge;
defining status according to one or more value of the status data;
calculating transition probability of the status by the RNN model; and
determining user operation corresponding to largest probability of status transition as next operation of the user.

3. The interface display method according to claim 1, wherein highlighting a functional component of the predicted operation of the user from the functional interface comprises strengthening display of the predicted functional component and/or weakening display of the non-predicted functional component.

4. The interface display method according to claim 1, wherein obtaining a present operation sequence by a user comprises checking validity of the operation by the user, wherein the user operation is valid if there is information interaction between user and functional interface component.

5. The interface display method according to claim 1, wherein the industrial domain knowledge is stored in an industrial domain knowledge base created by industrial knowledge graph.

6. An interface display apparatus for industrial software, the apparatus comprising:
an obtaining module to obtain a present operation sequence by a user in a functional interface of industrial software;
a prediction module using a recurrent neural network (RNN) model to predict a next operation of the user according to the present operation sequence by the user, wherein the RNN model is obtained through history operation sequence of the user and history operation sequence of typical users in industrial domain knowledge; and
an adjustment module to highlight a functional component of the predicted operation of the user from the functional interface and/or generating navigation corresponding to the predicted operation of the user.

7. The interface display apparatus according to claim 6, wherein using a RNN model to predict a next operation of the user comprises:
choosing a status data according to the industrial domain knowledge;
defining status according to one or more value of the status data;
calculating transition probability of the status by the RNN model; and
determining user operation corresponding to largest probability of status transition as next operation of the user.

8. The interface display apparatus according to claim 6, wherein highlighting a functional component of the predicted operation of the user from the functional interface comprises strengthening display of the predicted functional component and/or weakening display of the non-predicted functional component.

9. The interface display apparatus according to claim 6, wherein obtaining a present operation sequence by a user comprises checking validity of the operation by the user, wherein the user operation is valid if there is information interaction between user and functional interface component.

10. The interface display apparatus according to claim 6, wherein the industrial domain knowledge is stored in an industrial domain knowledge base created by industrial knowledge graph.

11. An electronic device comprising:
a processor;
a memory, storing an instruction;
wherein the instruction is executed by the processor to:
obtain a present operation sequence by a user in a functional interface of industrial software;
use a recurrent neural network (RNN) model to predict a next operation of the user according to the present operation sequence by the user, wherein the RNN model is obtained through history operation sequence of the user and history operation sequence of typical users in industrial domain knowledge; and
highlight a functional component of the predicted operation of the user from the functional interface and/or generating navigation corresponding to the predicted operation of the user.

12. (canceled)
